(19) United States
(12) Patent Application Publication
(10) Pub. No.: US 2024/0194365 A1
(43) Pub. Date: Jun. 13, 2024

(54) RADIOISOTOPE PRODUCTION TARGET FOR LOW MELTING POINT MATERIALS

(71) Applicant: Best Theratronics Ltd., Ottawa, Ontario (CA)

(72) Inventor: William Gelbart, Garden Bay, British Columbia (CA)

(21) Appl. No.: 18/554,010

(22) PCT Filed: Apr. 6, 2022
(86) PCT No.: PCT/CA2022/050518

§ 371 Date: Oct. 5, 2023

Related U.S. Application Data
(60) Provisional application No. 63/171,479, filed on Apr. 6, 2021.

(51) Int. Cl. G21G 1/10; G21G 1/00

(52) U.S. Cl. CPC G21G 1/10; G21G 2001/0094

(57) ABSTRACT

Embodiments of a target support plate and a method for manufacturing targets used for low melting point materials, typically Gallium and Rubidium, with commercial cyclotrons including various embodiments of the targets are described. The target for low melting point materials includes a target support plate having a front face and a back face, the front face having formed therein a plurality of slots to contain a target material: the plurality of slots is arranged to be in a horizontal position, with a grazing angle of 5° to 15°, with respect to the irradiation proton beam for initiating a nuclear reaction; and may include a plurality of cooling channels formed on the back face of the target support plate to cool the target support plate during formation of a radioisotope from the formed low melting point material by a flow of a cooling fluid therein during irradiation of the target.

### CROSS REFERENCE TO RELATED APPLICATION

The present invention claims priority to U.S. Provisional Application Ser. No. 63/171,479, filed Apr. 6, 2021, which is incorporated by reference herein in its entirety.

The invention generally relates to the field of radioisotope production, and more particularly to targets for irradiating low melting point materials to produce radionuclides.

### BACKGROUND

### Field of the Invention

Radioactive elements have been used in medicine since the discovery of Radium-226 by Marie and Pierre Curie in 1898. One such application of radioactive elements in the 2020s is in diagnostic imaging and therapy applications. Most medical radioactive elements currently used are cataloged in the IAEA publication “Medical Radioisotopes Production”. The radioactive elements are created by bombarding a stable element with energetic protons or particles thereby inducing a nuclear reaction resulting in the creation of the required radionuclide. The source of the particles used to bombard the stable element is an accelerator, which is in most installations a cyclotron.

The stable precursor elements can be in gaseous, liquid or solid state. However, many precursors are typically metallic elements. To facilitate the handling of those metallic elements, the accepted particle is clad in a solid substrate (usually in a copper or silver wafer or plate, but other materials may be used as well) with the precursor element, together forming what is known as a “target” or “solid target”.

The cladding of the target substrate can be performed in a number of ways such as including to electrodeposition, sputtering, laser cladding, diffusion bonding and foil soldering, but not limited thereto.

The target is subjected to heating from the bombarding beams during the production reaction. The heat generated by the particle beam can be significant. Modern cyclotrons can deliver 30 MeV or higher beam energies with over 1 mA of the particle beam currents, depositing 30 KW or more heat energy on to the target. This typically represents a thermal flux on the target face in the range of ˜107 W/m². To keep the precursor element on the target's substrate surface below its melting point, forced cooling is employed; the coolant flow is usually through cooling channels formed on the back of the target substrate. To reduce the thermal flux on the target face, the target is often placed at an angle to the beam thus spreading the beam over a larger area.

When using high melting point elements and with sufficient cooling, the substrate temperature can be kept comfortably below the melting point. For example, the current practice for stable metals whose melting temperature is low (e.g., Gallium-69 with a melting temperature of 29.8° C. or Rb-85 with a melting temperature of 39° C.) is to use an alloy or compound that melts at a higher temperature (e.g., Ga-4Ni with a 900° C. melting temperature or RbCl with a 718° C. melting temperature) or dissolving a compound that includes the stable metal and then exposing the compound solution to the bombarding beam in a liquid form in special targets designed for this purpose. As such, the desired target atoms available for the medical material is limited by the other material exposed to the beam. In other words, the quantity of the resulting medical material produced will be significantly less than would be created using a pure stable metal. This is even more evident in the case of liquid targets where the total beam power deposited is limited. Additional complication can arise due to the poor adhesion of the alloys or compounds to the substrate thus reducing the heat transfer coefficient and the beam powers those targets can handle. Another problem is the poor stability of some of the alloys. For example, Ga-4Ni starts to separate at about 200° C. causing loss of some of the Gallium content that flows off the target surface in the form of liquid droplets.

The irradiating particle beam typically generates high heat in the target material that even with cooling results in a temperature that exceeds the melting point of the target material can be reached. This will cause the melting of the target material and subsequent loss from the substrate.

A large percentage of commercial medical radioisotopes are produced by the bombarding of solid targets. The bombarding of the solid targets is typically facilitated by supplying those radioisotopes by employing sophisticated and expensive systems to transfer, manipulate and irradiate those targets. All those operations are performed and controlled remotely. Most solid targets that are designed to intercept high beam currents, typically in the range of about 5 KW to 50 KW, are placed at angles between 6° to 15° to the horizontal, incident beam delivered by the accelerator. For example, U.S. Pat. No. 11,062,816 to Johnson et al., incorporated herein by reference in its entirety discloses an elliptical Molybdenum target placed at an angle of 15° to the proton beam for producing Tc-99m. Other angles are possible as well. This technique works well with high melting point materials but precludes the use of low melting point materials that will liquefy during irradiation and flow off the target substrate.

With all the advantages of irradiating the precursor materials in their highest concentrated (pure) state, dedicated irradiation systems are employed in some facilities. One approach is to encapsulate the target material in a metallic container featuring thin metal foils on the beam entrance and exit (called “windows”). Those capsules are irradiated inside a water tank with a flow of water around the capsule. This approach, however, presents a number of following problems: (1) the creation of the disposable capsule is both labor and cost intensive; (2) it involves the use of a complex, dedicated system that precludes the use of different target systems and different materials; (3) it results in a loss of beam power; and (4) there is a danger of catastrophic failure as may result from window failure and water ingress into the capsule. For example, Rubidium reacts violently in the presence of water resulting in explosion and fire. This is not a practical option for a facility already equipped with solid targets irradiation systems—in fact the majority of existing radioisotope production facilities around the world.

While there have been some attempts to produce targets for low melting point materials, such attempts have not adequately addressed an efficient method and system to overcome the aforementioned drawbacks. Thus, an efficient target for producing radioisotopes from low melting point materials addressing the aforementioned needs is desired.

### SUMMARY OF THE INVENTION

Embodiments of target support plate and method for manufacturing targets used for low melting point materials with commercial cyclotrons and various embodiments of the targets are described.

The radioisotope production target for low melting point materials includes a target support plate having a front face and a back face. The front face having formed therein a plurality of slots to contain a target material; each of the plurality of slots being arranged to be in a horizontal position with respect to an incident irradiation beam for initiating a nuclear reaction. The back face of the target support plate can have a plurality of cooling channels being adapted to cool the target support plate during formation of a radioisotope from the formed low melting point material by a flow of a cooling fluid therein during irradiation of the target.

In a further embodiment, the target for low melting point materials may be constructed of a metallic substrate comprising copper, silver and aluminum and desirably having dimensions of length from about 120 mm to about 200 mm, a width of about 40 mm to about 70 mm and a thickness of about 2 mm to about 10 mm. The plurality of slots desirably having a width of from about 0.5 mm to about 6.0 mm, depth from about 1.0 mm. Each of the plurality of slots is separated by a thin section of the target substrate having a width ranging from about 0.1 mm to about 0.3 mm. The plurality of slots is filled with a solid or a liquid target material; and preferably the target material is solid Gallium-69 or Rubidium-85 metals, or other comparable suitable material.

In another embodiment to form the target for low melting point materials, the target support plate can be constructed of non-metallic substances such as graphite, ceramic, glass, polymers, oxides and composites.

In another embodiment to form the target for low melting point materials, the target support plate is coated by electroplating or other process with protective barrier layer. For example, the protective barrier layer can be formed from Gold (Au), Platinum (Pt), Iridium (Ir), Osmium (Os), Rhodium (Rh), Nickel (Ni), or a combination thereof. The protective barrier layer may be uniform or substantially uniform and have a thickness of about 0.01 mm, for example.

In another embodiment, a process for the production of a target for low melting point materials is described. The process for the production of a target for low melting point materials, includes providing a target support plate, the target support plate including a front face and a back face, the front face having formed therein a plurality of slots adapted to contain a target material and the back face having formed therein a plurality of slots adapted to cool the target support plate during formation of a radioisotope; loading the target material on to the plurality of slots positioned on the front face of the target support plate; positioning the target support plate in a target holder apparatus; irradiating the target with a proton beam having an energy sufficient to induce a nuclear reaction in the low melting point target material to produce the radioisotope; inserting a cooling fluid into each of the plurality of slots on the back face of the target support plate, collecting the irradiated low melting point target material by melting out the irradiated low melting point target material; and separating the irradiated target from the target support plate to form a separated irradiated low melting point target material.

A further embodiment of the process for the production of a target for low melting point material includes loading the target material in solid state as precast or preformed billets of the target material, or loading it in a liquid state, such as pouring a molten target material onto the target support plate while placing the target support plate at an angle to the irradiation proton.

In embodiment to form the target for low melting point materials, the target support plate is positioned to expose the plurality of the slots to the proton beam at a grazing incidence angle of about 5 to 15 degrees (°), preferably 8° configured to expose each slot completely to the incident irradiation proton beam.

These and other features of the present invention will become readily apparent upon further review of the following specification and drawings.

### DESCRIPTION OF THE DRAWINGS

FIG. 1 illustrates partial cross-sectional view of a typical solid target as used in most solid target irradiation systems and equipment.

FIG. 2 illustrates cross-sectional view of a typical solid target irradiation position in the irradiation equipment.

FIG. 3A is an exemplary rectangular target having a front face with grooves and a back face according to the present invention. FIG. 3B is a schematic diagram of the front face of the rectangular target containing a plurality of slots according to the present invention. FIG. 3C is the view of the back face of the rectangular target having cooling channels running along the length of the target according to the present invention.

FIG. 4A illustrates the cross sectional view of the exemplary solid target and FIG. 4B illustrate the front, or top, view with plural slots for the irradiation of low melting point materials according to the present invention.

FIG. 5 illustrates an enlarged view of item identified with the numeral 7 in FIG. 4A and is a detail of the cross-sectional view of the exemplary solid target with plural slots for the irradiation of low melting point materials according to the present invention.

FIG. 6A illustrates typical dimensions of the exemplary target according to the present invention; FIG. 6A-1 illustrates the cross section along the section line A-A of FIG. 6A showing the details of the cooling channels in the back; FIG. 6B illustrated the enlarged detail of a selected portion of the target of FIG. 6A-1; FIG. 6C is a cross-section of the exemplary target along the section line B-B of FIG. 6A; FIG. 6D shows the detailed view of a selected portion of FIG. 6C showing the enlarged view of the slots, thin wall of the substrate and the angle of the slots according to the present invention.

FIG. 7 displays the thermal modeling of the exemplary solid target with plural slots for the irradiation of low melting point materials, under irradiation conditions, showing the temperature distribution of the material in each slot according to the present invention.

FIG. 8 is a schematic flow chart of an exemplary process of preparing a low melting point target and removing the irradiated target according to the present invention.

Unless otherwise indicated, similar reference characters denote corresponding features consistently throughout the attached drawings.

### DETAILED DESCRIPTION

The present disclosure relates to solid targets for the production of radioisotope from low melting point materials. As described herein, embodiments of the solid target include a target substrate plate having a front face and a back face. The front face includes a plurality of cavities such as slots or grooves, adapted to contain a target material. The cavities can be machine formed to be horizontally oriented when the target substrate is placed in the incident irradiation beam direction. The target material can be loaded in solid or liquid state into the plurality of slots. During irradiation the target material melts, but is contained within the slots or cavities during irradiation. At the end of irradiation process the target material cools down and solidifies due to the lowering of the temperature from its melting point, thereby allowing regular form of target handling similarly as for any solid target known to those skilled in the art.

In a desired embodiment of this invention, for example, a solid copper substrate target is provided with plural slots to contain the low melting point precursor material in a solid state before irradiation, thus allowing the same target transfer and manipulation techniques to be used as with the existing solid targets. The target substrate desirably is a solid substrate, such as can be formed of copper, silver, aluminum or other suitable materials, as can depend on the use or application and should not be construed in a limiting sense. While the target substrate is desirably formed of a metallic material, such as a metallic material including copper, or combinations thereof, the target substrate can also be formed of a non-metallic material or a non-metal material, as can depend on the use or application, and should not be construed in a limiting sense. The same slots contain the low melting point material in a liquid state after its melting during irradiation due to the heat generated by the proton particle beam. At the end of irradiation, the low melting point material quickly solidifies by the cooling effect of the target coolant flow, thereby allowing the same ease of the target transfer and manipulation readily known to those skilled in the art. The low melting point material can be Gallium-69 and wherein the radioisotope created can be Germanium-68, however the low melting point material can be of various suitable materials, as can depend on the use or application and should not be construed in a limiting sense.

Targets used to produce radioactive materials are typically subject to a number of operational constraints. For example, the targets (1) must withstand the temperatures generated during irradiation and be fashioned to accommodate temperature gradients from in situ cooling; (2) must be resilient and (3) should not substantially disintegrate during irradiation or post processing, because of the radioactive nature of the products. The exemplary disclosed targets in the accompanying figures were designed specifically for low melting point materials such as Gallium (Ga) but can including other metals such as Rubidium (Rb), and should not be construed in a limiting sense.

As used herein the term “low melting point materials” includes various suitable materials, such as including elements of the periodic table that have a melting point around or below 250° C. and can include elements such as Gallium (Ga) and Rubidium (Rb). However, suitable low melting point materials used can depend on the use or application, and should not be construed in a limiting sense.

Advantageously, in the desirable embodiment of this invention, for example, a solid style target is provided with plural slots on the front face to contain the low melting point precursor material in a solid state before irradiation, thus allowing the same target transfer and manipulation as with the existing solid targets. The same slots contain the low melting point material in a liquid state after its melting during irradiation due to the heat generated by the particle beam. At the end of irradiation, the low melting point material quickly solidifies by the cooling effect of the target coolant flow allowing the same ease of the target transfer and manipulation.

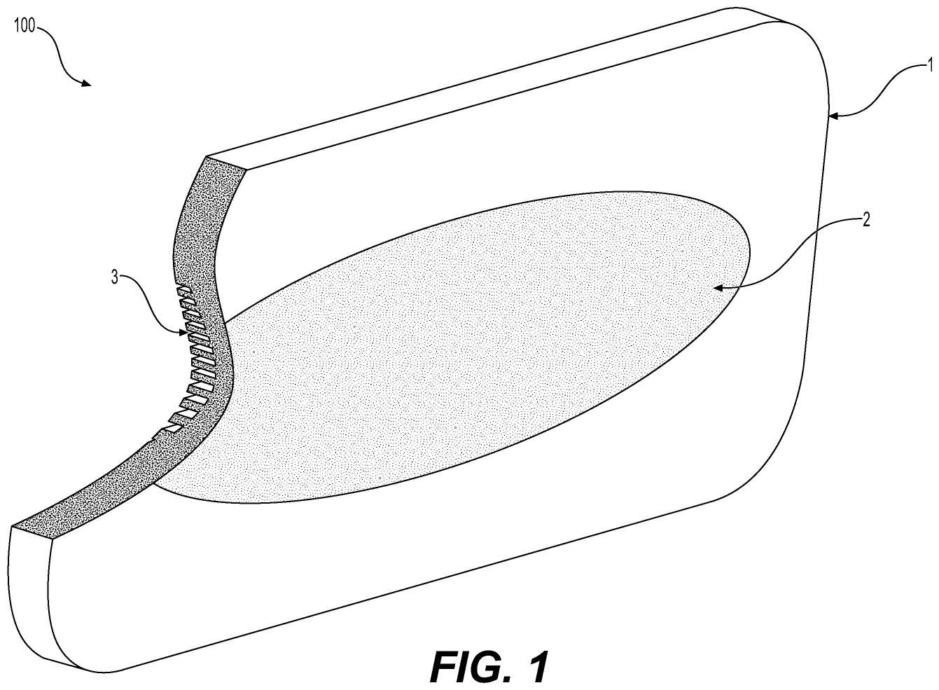

Referring now to FIG. 1, a typical rectangular shape of a known target 100, such as disclosed in U.S. Pat. No. 11,062,816 to Johnson et al., incorporated herein by reference in its entirety, as used for the irradiation of solid materials is shown. The exemplary target 100 includes the metallic target substrate or target support plate (1) surface to face the particle beam is clad with the precursor material (2). The partial section indicated by the numeral (3) shows the typical arrangement of the cooling channels at the back of the target plate.

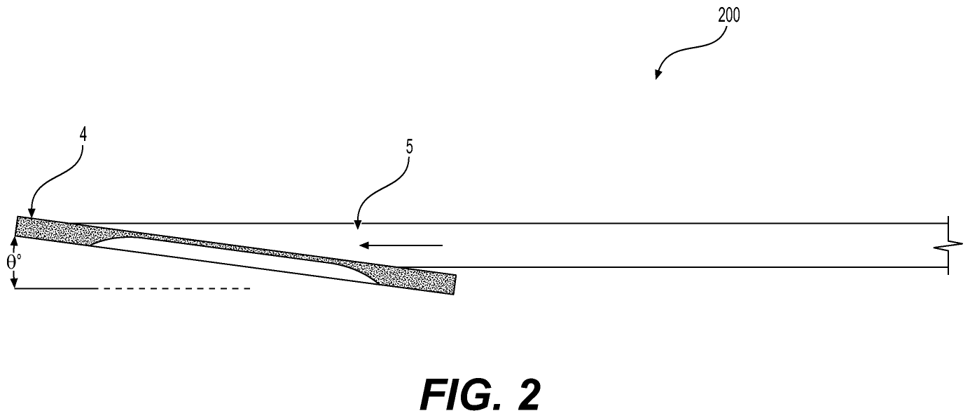

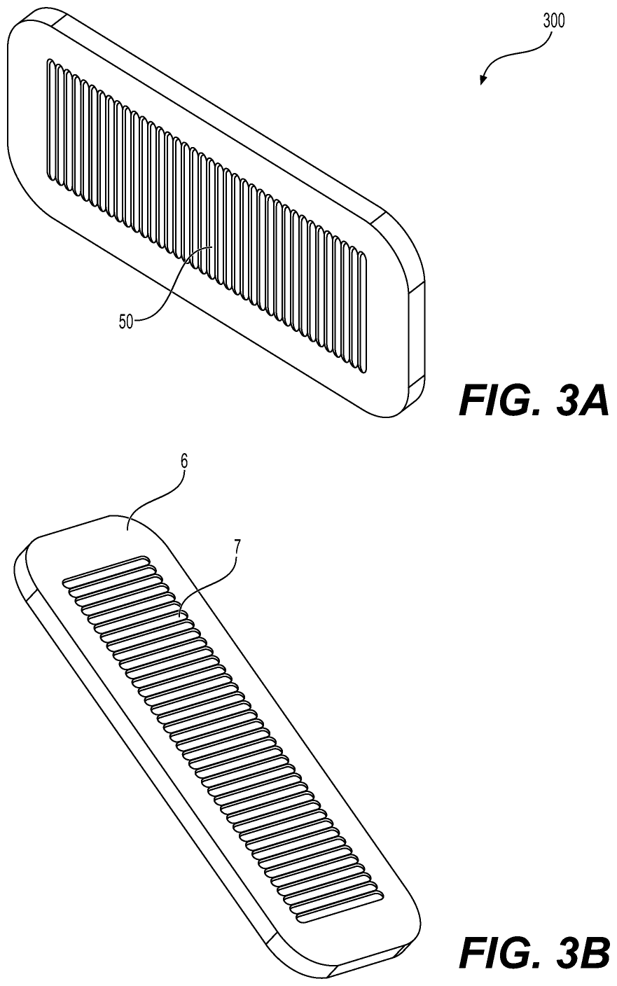

FIG. 2 shows a sectional view 200 of the typical angular alignment of the solid target (100) of FIG. 1 during irradiation. The target substrate, carrying the cladding of the precursor material (4) is placed at an angle (θ) typically 0° to 15° to the horizontally delivered particles beam (5) as the beam is extracted out of the particle accelerator. The beam is usually collimated to impend only on the precursor material covered area. This target works well with high melting point materials such as Molybdenum (Mo) but typically precludes its use with low melting point materials that liquefy during irradiation and flow off the target substrate.

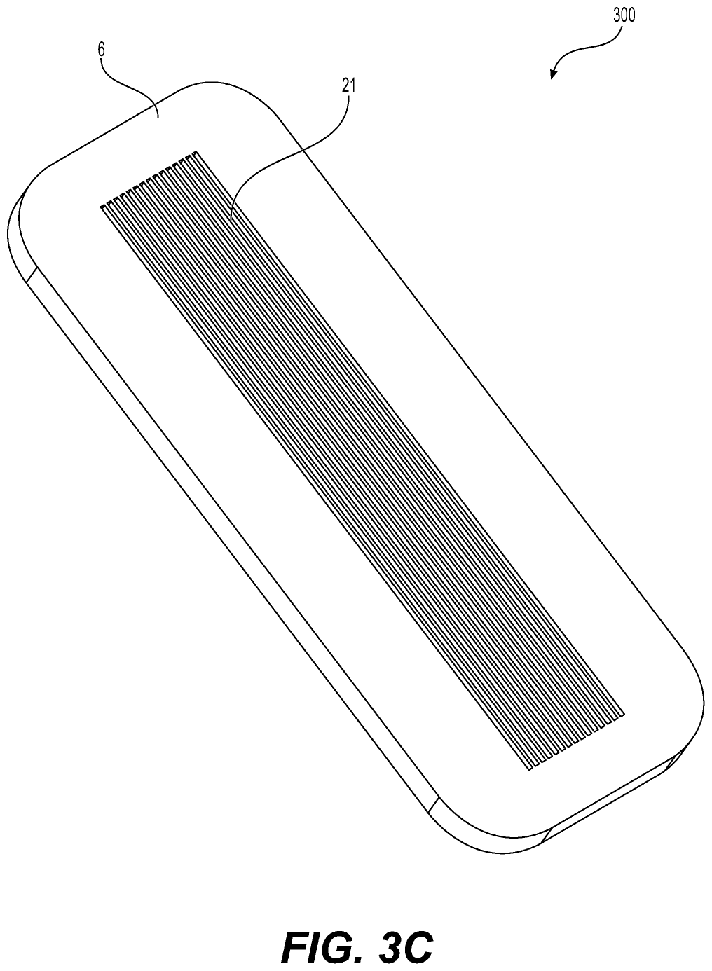

In an exemplary embodiment of a target (300), a three-dimensional geometry of the solid target (300) with plural slots for the irradiation of low melting point materials according to the present invention is shown in FIG. 3A. The exemplary target (300) has a rectangular shaped front face having a plurality of slots, such as fifty (50) slots, for example, and a back face. FIG. 3B illustrates the front face of the target (300) as the exemplary rectangular target machine fabricated with plural grooves or slots indicated by the detail of the slots (7). An exemplary geometry of the plurality of cooling channels (21) of the target (300) on the target plate is shown in FIG. 3C. Desirably, the plurality of cooling channels (21) is of generally rectangular shaped and arranged in a generally parallel, spaced apart relation, as shown in FIG. 3C, for example. However, in other exemplary embodiments, the solid target (300) can be formed without the cooling channels (21), such as when the cooling medium is a gaseous medium, for example, as can depend on the use or application and should not be construed in a limiting sense. The target substrate of the target (300) desirably is formed as a solid substrate, such as can be formed of copper, silver, aluminum, or combinations thereof, or other suitable materials, as can depend on the use or application, and should not be construed in a limiting sense.

While the target substrate is desirably formed of a metallic material, such as a metallic material including copper, the target substrate can also be formed of a non-metallic material or a non-metal material, as can depend on the use or application, and should not be construed in a limiting sense. In another embodiment to form the target for low melting point materials, the target support plate can be constructed of non-metallic substances such as ceramic, glass, polymers, oxides and composites.

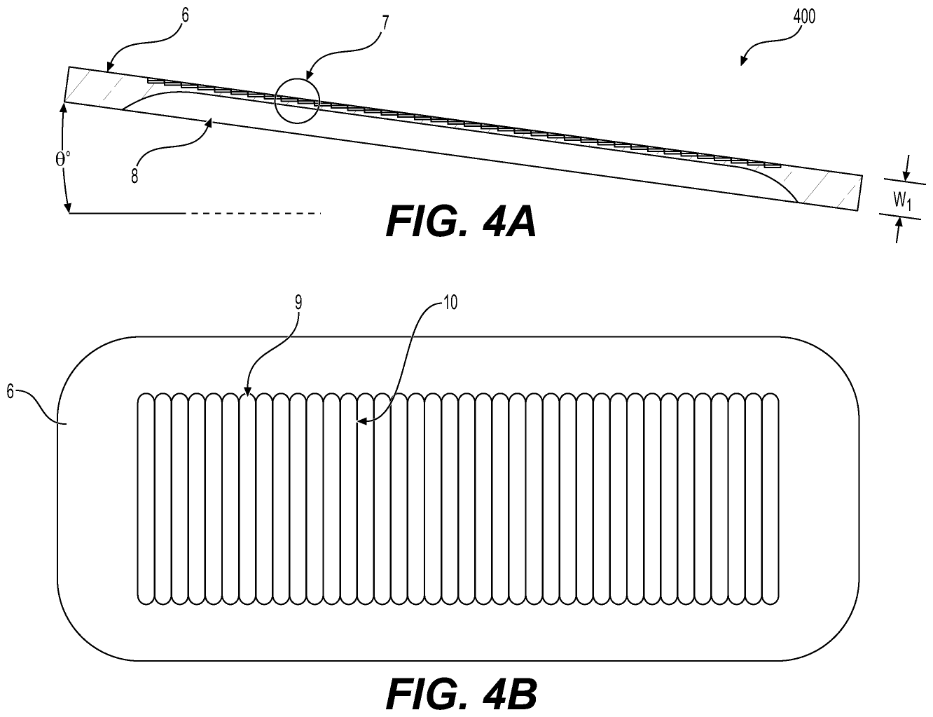

In another exemplary embodiment, referring now to FIGS. 4A and 4B, the side view (FIG. 4A) and the front, or top, view (FIG. 4B) of an exemplary target (400) according to the invention is shown. As shown in the cross-sectional view of FIG. 4A, the target (400) has a target substrate or target support plate (6), having a thickness, W₁, typically of about 5 mm to about 8 mm, and is typically a standard solid target substrate, such as copper, for example, featuring the same or other suitable construction materials, and dimensions, and having a plurality of cooling channels (8), as the target substrate employed for solid targets irradiation using the target (400), such as can be irradiated by existing target irradiation equipment. The target substrate of the target (400) desirably is formed as a solid substrate, such as can be formed of copper, silver, aluminum, or combinations thereof, or other suitable materials, as can depend on the use or application, and should not be construed in a limiting sense. While the target substrate is desirably formed of a metallic material, such as a metallic material including copper, the target substrate can also be formed of a non-metallic material or a non-metal material, as can depend on the use or application, and should not be construed in a limiting sense.

Also, in other exemplary embodiments, the target (400) can be formed without the cooling channels (8), such as when the cooling medium is a gaseous medium, for example, as can depend on the use or application and should not be construed in a limiting sense. The front face of the target (400) is slotted to carry plural slots (9) or grooves arranged to be horizontal when the target (400) is placed at the incident irradiation angle, typically from 6° to 15°, or any other suitable angle, preferably 8° to the beam direction axis employed in the irradiation system. FIG. 4A illustrates a detailed view of the slots (9) of FIG. 4B in the detail indicated by the numeral (7) in FIG. 4B, similar to the detail of the slots (7) in of FIG. 3A. As shown in the front, or top, view of FIG. 4B, the plural slots (9) are separated by a thin section (10) of the target substrate or target support plate (6) created during the formation of the slots (9). The slots typically do not communicate with each other and have a width typically in the range of about 0.1 mm to about 0.3 mm, for example. The slots (9) are formed, for example, with the slot longitudinal side perpendicular (90°) to the incident proton beam in order to contain the low melting point material from flowing out of the plate.

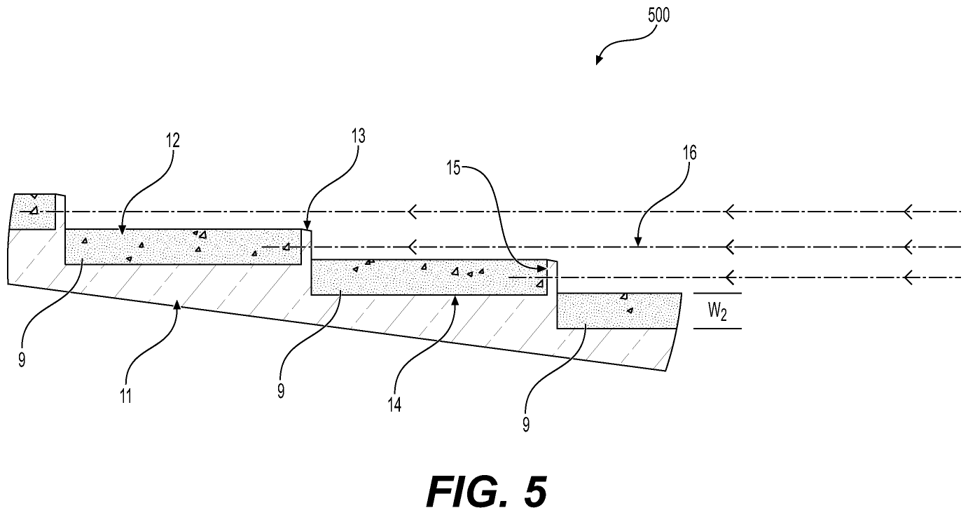

In FIG. 5 there is shown an enlarged view (500) of the slots (9) of the detail of the slots (7) of the section of FIG. 4A. Item numeral (11) is the target substrate or target support plate with the plural slots (9) filled up and containing the target precursor material (12) such as Gallium (Ga) or Rubidium (Rb) for example. Other suitable precursor materials for the target precursor material (12) can be used, as can depend on the use or application, and should not be construed in a limiting sense. The thin wall or section (13) of the target substrate (6) (FIG. 4A) separating the slots (9) is desirably kept to a practical minimum thickness, typically in the range of about 0.1 mm to about 0.3 mm, determined by the slot fabrication method, which is generally a fraction of a millimeter. The width of each of the slots (9) illustrated in FIG. 5, such as across a bottom surface (14) of a slot (9) is calculated or determined to provide the required thickness of the precursor material to achieve the optimal production of the radionuclide, typically in the order of, but not limited to, a few millimeters, typically in the range of about 0.5 mm to about 6.0 mm, desirably about 3.0 mm, for example. The dimensions can depend on the particular use or application and should not be construed in a limiting sense.

In exemplary embodiments, such as in the target (300) or in the target (400), the number of slots (9) on the target support plate (6) is typically by default governed or determined by the target design angle to the incident beam, the optimal slot width and the thickness of the separating sections, for example. The length of each slot, such as a slot (9) is determined by the shape of the collimated beam striking the target's font face and not extending at all, or not extending significantly beyond that boundary. The length of each of the slots, such as a slot (9), can desirably be in the range of about 30 mm to about 60 mm, for example, and should not be construed in a limiting sense. The slots (9) can be of equal or varied lengths, for example. The depth (15) of each slot (9), indicated by W₂, is in an equivalent way determined and governed by the default target design and the required slot width and are typically in the range of about 1 mm to about 5 mm, for example. The slots (9) are arranged in such a way as to align each slot top surface of a slot (9), such as indicated by the arrowhead associated with the numeral (12), with the consecutive slot's bottom surface (14) such that all the slots (9) are desirably equally or substantially equally exposed to the incident proton beam. During irradiation, a particle beam (16), for example a proton beam, is penetrating the thin wall (13) between consecutive slots (9) and is absorbed by the target precursor material, thereby inducing the nuclear reaction resulting in the production of the desired radionuclide. The incoming particle beam (16) energy is slightly attenuated by the thin wall (13) between consecutive slots (9), but typically 95% to 98% of the beam power is transmitted into each slot volume of the slot (9). This, combined with the theoretically maximum possible concentration of the target atoms (at the given material temperature), typically provides 95% to 98% production efficiency of the desired radioisotope, for example.

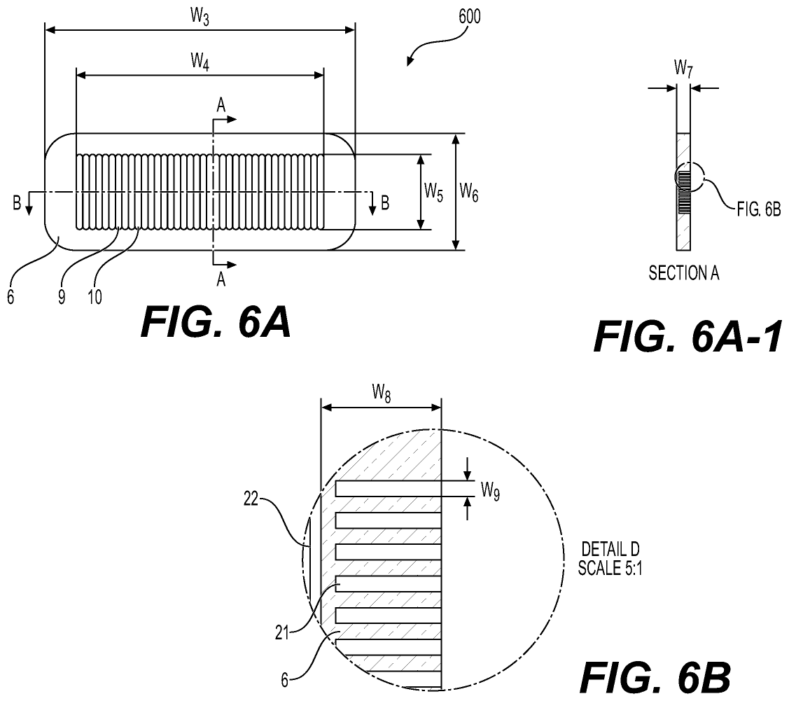

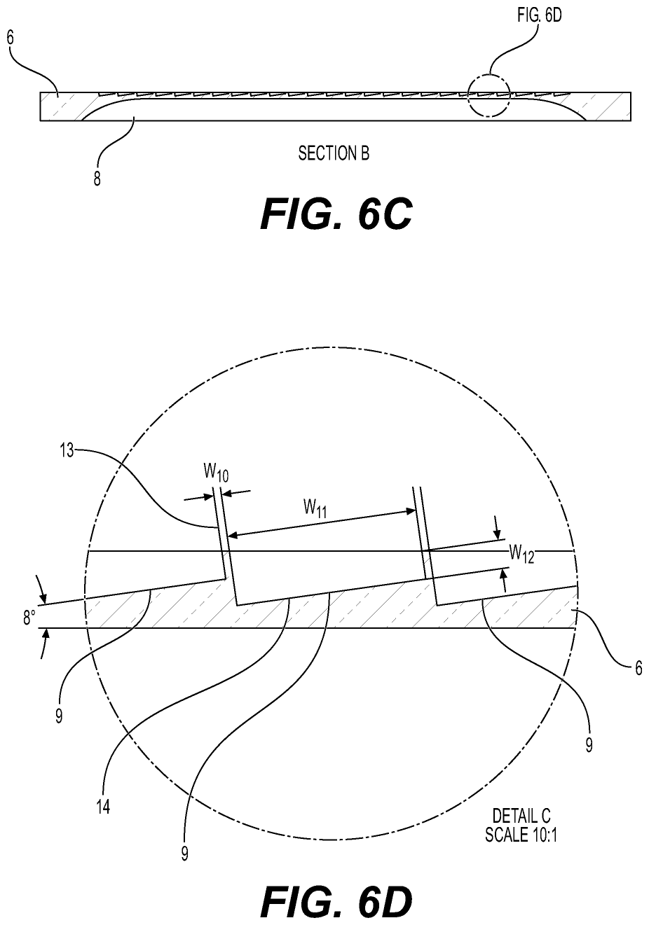

In another exemplary embodiment, FIGS. 6A-D shows detailed view of an exemplary target (600) for low melting point material of this invention. FIG. 6A shows the top view of the exemplary target (600) having, for example, a longitudinal dimension, W₃, typically of about 160 mm and a transverse dimension, W₆, typically of about 60 mm. The plural slots (9) or grooves (9) are arranged in a stepped configuration, separated by the thin section (10) of the target substrate or target support plate (6), having an overall longitudinal dimension, W₄, for the total slots (9) typically in the range of about 120 mm and a transverse dimension, W₅, of about 40 mm, for example. FIG. 6A-1 shows the cross sectional (Section A) view taken along the section line A-A in FIG. 6A showing the thickness of the target, W₇, typically of about 6.2 mm, for example, including the grooves of the cooling channels (21) (FIG. 6B) on the back face of the target (600). The target substrate, such as including the target support plate (6) of the target (600) desirably is formed as a solid substrate, such as can be formed of copper, silver, aluminum or other suitable materials, as can depend on the use or application and should not be construed in a limiting sense. While the target substrate, such as including the target support plate (6), is desirably formed of a metallic material, such as a metallic material including copper, or combinations thereof, the target substrate, such as including the target support plate (6), can also be formed of a non-metallic or a non-metal material, as can depend on the use or application, and should not be construed in a limiting sense. Also, in other exemplary embodiments, the target (600) can be formed without the cooling channels (21), such as when the cooling medium is a gaseous medium, for example, as can depend on the use or application and should not be construed in a limiting sense. The enlarged view “FIG. 6B” shows the top (22) of the slot (9) and the plurality of the cooling channels (21) having a typical width, W₉, in the range of about 0.5 to about 1.0 mm, desirably 0.8 mm, for example, on a target substrate or target support plate (6) of the target (600), and having a typical depth in the range of 4 mm to 8 mm, desirably about 5 mm, for example. However, the aforementioned dimensions and the dimensions in the following paragraph of the target (600) are examples of suitable dimensions for the target (600), and the dimensions used for the target (600), as can depend on the use or application, should not be construed in a limiting sense.

In FIG. 6C there is shown the cross section “B” taken along the section line B-B of FIG. 6A of the target (600) displaying the stepped slots (9) on the front face and the cooling channels (8) on the back face of the target (600). The enlarged view “FIG. 6D” shows the detail in FIG. 6C of the arrangement of the plurality of slots (9) having a typical dimension, W₁₁, across the bottom surface (14) of the slot (9) in the range of about 0.5 mm to about 6 mm, desirably about 3.0 mm separated by the thin wall (13) between adjacent slots (9), the thin wall (13) having typical dimensions, W₁₀, in the range of 0.1 mm to 0.3 mm, desirably 0.1 mm, for example. The height from the base of the thin wall (13) measured from the bottom surface (14) of a slot (9) between consecutive or adjacent slots (9) to a top surface of the slot (9), W₁₂, is typically from 0.3 to 0.6 mm, desirably 0.4 mm, for example. The slots (9) are created at an angle typically of about 5° to about 15°, desirably 8°, with respect to the horizontal top surface of the target substrate or target support plate (6). The dimensions of the slots (9) and the cooling channels (21) can depend on the particular use or application and should not be construed in a limiting sense. The plurality of cooling channels (21) provides a means to cool the target (600) by passing either a cooling liquid or simply by air circulation. When the cooling fluid, is water, for example, the cooling fluid flows in the cooling channels (21), such as during irradiation of the target (600). The cooling fluid can desirably enable the temperature of the target substrate or target support plate (6) to be held at a desirable temperature, for example. Also, in other exemplary embodiments, embodiments of the target (600) as well as embodiments of the targets (300) and (400), such as when formed without the cooling channels, such as formed with the cooling channels (8) of the target (400) and without the cooling channels (21) of the target (600), such as when the cooling medium is a gaseous medium, for example, the target, such as the targets (300), (400 or (600). The target including the target support plate of the target is adapted to be cooled by a cooling medium during formation of a radioisotope from the formed low melting point material by a flow of the cooling medium across at least the back face of the target support plate, the cooling medium used for cooling can depend on the use or application and should not be construed in a limiting sense.

The exemplary target substrates or target support plates, a thin section (10) of the target substrate or target support plate (6), such as for the targets (300), (400), and (600), for example, are usually constructed of high thermal conductivity metals, including but not limited to silver, copper and aluminum. Copper has been chosen as a desirable material for forming a target support plate because of its relatively good thermal properties, which makes it an ideal or very suitable material for heat transfer during irradiation. Copper is a ductile material and is suitable for relatively easy machining. However, the corrosive action of some of the liquid target precursor material, depending on the combination of the substrate and the target precursor material, can attack the substrate. In those cases, the substrate metal can be protected by a thin layer of a barrier material that would not be affected by the corrosive action, for example.

In other exemplary embodiments of the target, such as for the targets (300), (400), and (600), for example, the target substrate or target support plate, such as the target substrate or target support plate (6), is passivated with a protective barrier layer. The protective barrier layer can be, but is not limited, to Gold (Au), Platinum (Pt), Iridium (Ir), Osmium (Os), Rhodium (Rh), Nickel (Ni), or a combination thereof. The protective layer is uniform or substantially uniform and deposited with a thickness of typically in the order of 0.01 mm, but other thicknesses are possible and not limited thereto, for example. One way to apply this protective layer is by electroplating, for example, but other coating processes can be used as well and not be limited to the embodiments described above.

Advantageously, this invention provides the means to irradiate the target, such as for the targets (300), (400), and (600), for example, with higher beam powers than targets clad with an alloy or a compound (for example Ga-4Ni and RbCl). Liquid metals for the target material in contact with the target substrate or target support plate typically exhibit a high and reliable heat transfer coefficient. This is in contrast with cladded target substrates where the cladding adhesion strength is mostly unknown and can sometimes be poor. The loss of contact between the target substrate and the cladding will result in the loss of heat transfer and the melting of the cladding material in the areas of the lost contact.

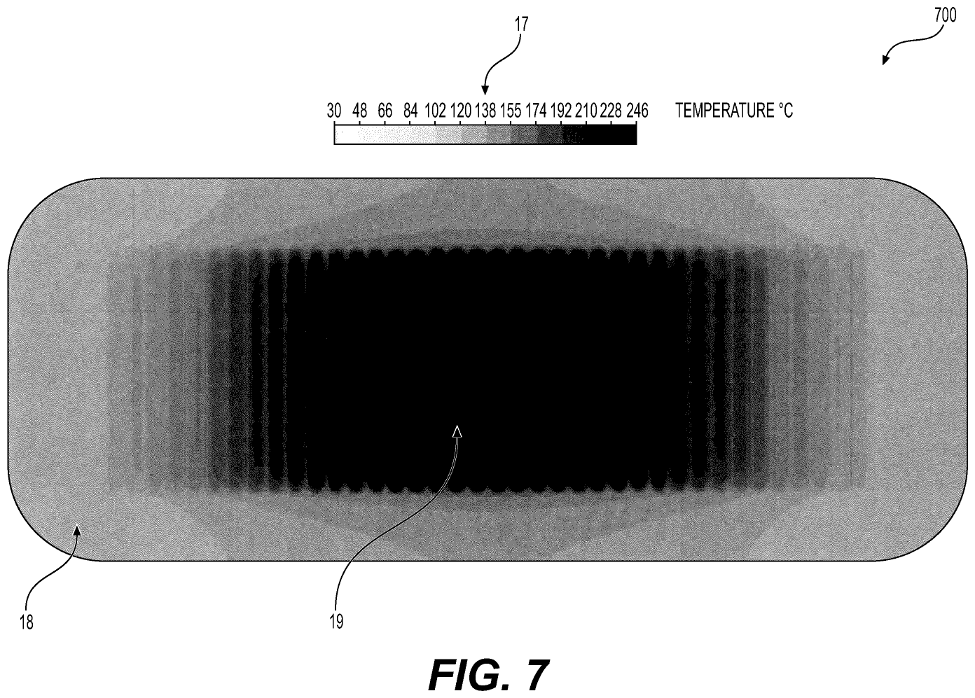

Referring to FIG. 7, there is illustrated an exemplary result of a thermal simulation (700) of a typical slotted (grooved) target, such as the targets (300), (400), and (600), for example, carrying Gallium-69. A phenomenon that typically limits the beam power on solid targets is the Gaussian profile of the particle beam creating a central hot spot on the target face at the Gaussian peak. Liquid target material in a target according to the invention typically is minimally affected or not substantially affected from this phenomenon as the heat is evenly distributed along each groove by the constant self-mixing of the liquid. The simulation (700) assumes 32 KW beam power on an area of 34 cm² with 50 l/min, 20° C. cooling water flowing through the cooling channels. Those are in fact typical values encountered in current practices in the art. In the simulation (700), the target substrate outside the irradiation area (18) is at 30° C., while that of the hottest slot (groove 19) is at a temperature of 246° C., for example. The temperature values in the simulation (700) are indicated by the bar (17), as can depend upon the position on the target substrate of the target, for example.

In exemplary embodiments, such as for the targets (300), (400), and (600), for example, the target prepared for irradiation has the slots (grooves) filled with the desired low melting point target material, such as Gallium-69 or other similar materials of a low melting point. This can be done in a number of ways, including but not limited to loading of each groove with precast or preformed billets of the appropriate size or by placing the target on a hot plate at the irradiation angle and filling the slot by pouring the molten material into each slot. Upon cooling and solidification, the target can be handled just like any other solid target as long as it is kept at a temperature below the material melting point. For most materials used in or as target materials in targets according to the invention, the melting point of the low melting point material is typically above the normal room temperature (about 25° C.) encountered in production facilities, for example.

In further exemplary embodiments, such as for the targets (300), (400), and (600), for example, the irradiated target is processed to separate the created radionuclide from the irradiated precursor material. In the case of the slotted (grooved) target for low melting point materials, the target material is collected from the substrate by melting it, for example. The collected melt is processed using a process suitable for the separation, such as thermal distillation and column chromatography techniques, for example, as readily known to those skilled in the art.

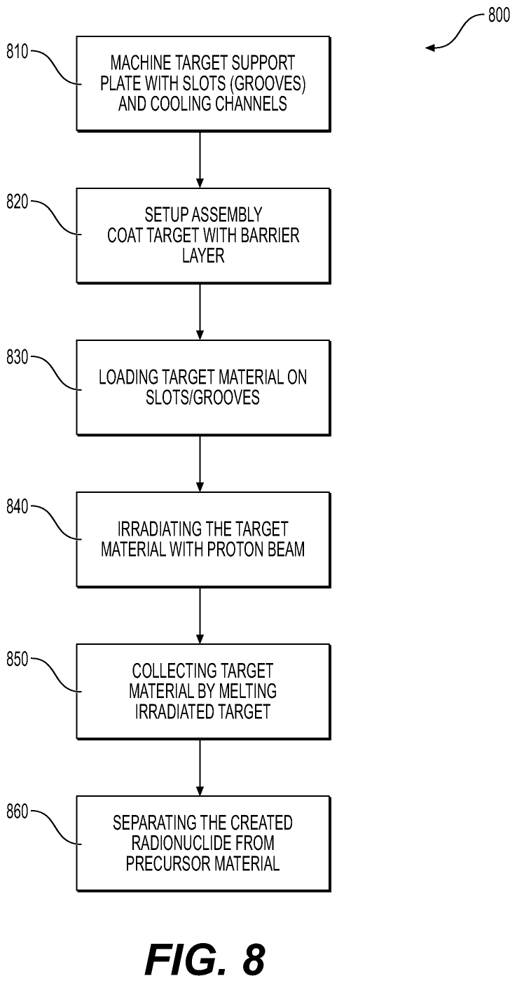

Referring now to FIG. 8, an exemplary process (800) for manufacturing the targets, such as for the targets (300), (400), and (600), for example, for low melting point materials is illustrated. The exemplary process (800) includes various steps including the steps of machining a target support plate (810), such as the target support plate (6), the material of the target support plate being copper or a material including copper, for example, which can include machining the grooves or slots, such as the grooves or slots (9) and the cooling channels, such as the cooling channels (21); setting up the target assembly (820) for forming the target, desirably includes coating the slots or grooves (9) of the target support plate (6) with a protective material, such as desirably electroplating the slots or grooves (9) of the target support plate (6) with a protective barrier coating of nickel, gold, or ones of the platinum group metals as a protective barrier, such as coating the slots or grooves (9) of the target support plate (6) with a protective barrier layer formed with a protective barrier layer from Gold (Au), Platinum (Pt), Iridium (Ir), Osmium (Os), Rhodium (Rh), Nickel (Ni), or a combination thereof, for example; loading the low melting point target material on to the plurality of the slots or grooves, such as the slots or grooves (9) on the face of a copper, for example, target support plate with precast or preformed billets of the appropriate size or the low melting point target material being in liquid state (830); irradiating the low melting point target material in the target support plate with a proton beam from a cyclotron (840); collecting the irradiated low melting point target material by melting the irradiated low melting point target material (850); and finally separating from the collected separated irradiated low melting point target material a created radioisotope or radionuclide from precursor material formed by the irradiation of the low melting point material (860). The irradiation power and time in the process (800), for example, can depend and vary on the type of low melting point target material. The process (800) could further include methods of separating the radionuclide created by nuclear reaction of the proton beam with the low melting point target material by known methods in the art and, as such, the exemplary process (800) should not be construed in a limiting sense.

In another exemplary embodiment, such as for the targets (300), (400), and (600), for example, during irradiation, a cooling fluid, such as the flow of the water, can be desirably used to cool the target support plate for low melting point materials and the flow ranges can be from about 2 Liters/minute to about 10 liters/minute, for example, to keep the target plate from over-heating. In yet another embodiment, such as for the targets (300), (400), and (600), for example, a steady flow of forced air over the target can be used to cool the target plate for low melting point materials with methods known to those skilled in the art.

Embodiments of the exemplary target of this invention can overcome various difficulties that typically can be encountered by previously known targets in the art. In an advantage provided by this invention, for example, the existing solid target irradiation systems, as already installed in many facilities, can be utilized to irradiate the low melting point materials contained in embodiments of targets of this invention in the same irradiation equipment that is routinely used for the production of other radionuclides. Another advantage of this invention is that it provides a means of using the same or substantially the same solid target construction compatible with the existing equipment and the processes routinely used and thereby typically does not depart significantly from the established procedures, protocols and the existing equipment licenses of an irradiation facility, for example.

It is to be understood that the present invention is not limited to the embodiments described above, but encompasses any and all embodiments within the scope of the following claims.

1. A radioisotope production target for low melting point materials, comprising:
a target support plate having a front face and a back face, the front face having formed therein a plurality of slots to contain a target material of a low melting point at or below 250° C.; and
a plurality of cooling channels formed on the back face of the target support plate; the plurality cooling channels being adapted to cool the target support plate during formation of a radioisotope from the formed low melting point material by a flow of a cooling fluid therein during irradiation of the low melting point material.

2. The radioisotope production target for low melting point materials of claim 1, wherein the target support plate is constructed having a solid metallic substrate and is formed of a material comprising copper, silver, aluminum, and combinations thereof.

3. The radioisotope production target for low melting point materials of claim 1, wherein the target support plate is constructed of a non-metallic material or a non-metal material selected from the group of graphite, ceramic, glass, oxides, polymers and composites.

4. The radioisotope production target for low melting point materials of claim 1, wherein the plurality of slots is arranged to be in a horizontal position with respect to an incident irradiation beam for initiating a nuclear reaction of the low melting point material.

5. The radioisotope production target for low melting point materials of claim 1, wherein the plurality of slots is arranged to align each slot top surface with a next consecutive slot's bottom surface.

6. The radioisotope production target for low melting point materials of claim 1, wherein said plurality of slots can be of equal or varied lengths.

7. The radioisotope production target for low melting point materials of claim 1, wherein a width of each of the plurality of slots is in a range of from about 0.5 mm to about 6.0 mm and wherein a depth of each of the plurality of slots is in a range of from about 1.0 mm to about 5.0 mm.

8. The radioisotope production target for low melting point materials of claim 1, wherein a thin wall formed in the target support plate separates a slot from an adjacent slot within the plurality of slots.

9. The radioisotope production target for low melting point materials of claim 8, wherein a width of the thin wall is in a range of from about 0.1 mm to about 0.3 mm; and wherein an incident irradiation beam penetrates said thin wall thereby inducing a nuclear reaction in the low melting point material.

10. The radioisotope production target for low melting point materials of claim 1, wherein the target support plate is held at an irradiation angle in a range of about 5° to about 15° with respect to an incident irradiation beam configured to expose each slot of the plurality of slots to the incident irradiation beam.

11. The radioisotope production target for low melting point materials of claim 1, wherein the target support plate has a length in a range of from about 120 mm to about 200 mm, a width in a range of from about 40 mm to about 70 mm and a thickness in a range of from about 2 mm to about 10 mm.

12. The radioisotope production target for low melting point materials of claim 1, wherein the plurality of cooling channels is arranged in a longitudinal direction or in a perpendicular direction on the back face of the target support plate.

13. The radioisotope production target for low melting point materials of claim 1, further comprising:
a target material of the low melting point material filled within each of said plurality of slots, and
wherein the target material is selected from the group consisting of Gallium-69 and Rubidium-85.

14. The radioisotope production target for low melting point materials of claim 13, wherein the target material is in a solid state or in a liquid state.

15. The radioisotope production target for low melting point materials of claim 13, wherein a thickness of the target material in each of the plurality of slots is in a range of from about 0.5 mm to about 2 mm.

16. The radioisotope production target for low melting point materials of claim 1, wherein the target support plate is electroplated with a layer of a barrier material selected from the group consisting of Gold (Au), Platinum (Pt), Iridium (Ir), Osmium (Os), Rhodium (Rh), Nickel (Ni), or a combination of thereof.

17. The radioisotope production target for low melting point materials of claim 16, wherein a thickness of the barrier material is about 0.01 mm.

18. A radioisotope production target for low melting point materials, comprising:
a target support plate having a front face and a back face, the front face having formed therein a plurality of slots to contain a target material of a low melting point at or below 250° C.; wherein
the back face of the target support plate is formed without cooling channels and the target support plate is adapted to be cooled by a cooling medium during formation of a radioisotope from the formed low melting point material by a flow of the cooling medium across at least the back face of the target support plate.

19. A process for the production of a target for low melting point materials, comprising the steps of:
(i) providing a target support plate having a front face and a back face, the front face having formed therein a plurality of slots to contain a target material having a low melting point at or below 250° C.; and providing a plurality of cooling channels formed on the back face of the target support plate, the plurality of cooling channels being adapted to cool the target support plate during formation of a radioisotope or a radionuclide from the low melting point target material by a flow of a cooling fluid therein during irradiation of a low melting point target material;
(ii) loading the low melting point target material into said plurality of slots in the target support plate;
(iii) placing the target support plate in a target holder apparatus;
(iv) irradiating the low melting point target material in the target support plate with a proton beam having an energy to induce a nuclear reaction in the low melting point target material to produce the radioisotope or the radionuclide;
(v) flowing a cooling fluid through the plurality of cooling channels during irradiation of the low melting point target material formed in the target support plate of the target;
(vi) collecting said irradiated low melting point target material from the target support plate by melting out said irradiated low melting point target material from the target support plate to separate the irradiated low melting point target material from the target support plate; and
(vii) separating from the collected separated irradiated low melting point target material the radioisotope or the radionuclide created from precursor material formed by the irradiation of the low melting point material.

20. The process for the production of a target for low melting point materials of claim 19, wherein said loading the low melting point target material comprises loading the low melting point target material into said plurality of slots in a solid state as precast or preformed billets of the low melting point target material.

21. The process for the production of a target for low melting point materials of claim 19, wherein said loading of the low melting point target material comprises loading the low melting point target material in a liquid state and comprises pouring a molten low melting point target material in the plurality of slots while placing the target support plate at an angle to the proton beam to be used for the irradiation of the low melting point target material.

22. The process for the production of a target for low melting point materials of claim 19, wherein said low melting point target material is Gallium-69 and wherein the radioisotope produced is Germanium-68.

23. The process for the production of a target for low melting point materials of claim 19, wherein the energy of the proton beam irradiating the low melting point target material is in a range of from about 1.0 to 10 Megaelectron-volts (MeV) generated by a cyclotron.

24. The process for the production of a target for low melting point materials of claim 19, wherein the low melting point target material formed in the plurality of slots in the target support plate is exposed to the proton beam at a grazing incidence angle of about 6 to 15 degrees (°).

25. The process for the production of a target for low melting point materials of claim 19, wherein the step of placing the target support plate in a target holder apparatus further comprises electroplating at least the plurality of slots in the target support plate with a layer of a barrier material selected from the group consisting of Gold (Au), Platinum (Pt), Iridium (Ir), Osmium (Os), Rhodium (Rh), Nickel (Ni), or a combination of thereof.

26. A process for the production of a target for low melting point materials, comprising the steps of:
(i) providing a target support plate having a front face and a back face, the front face having formed therein a plurality of slots to contain a target material having a low melting point at or below 250° C., wherein the back face of the target support plate is formed without cooling channels and the target support plate is adapted to be cooled by a cooling medium during formation of a radioisotope from the formed low melting point material by a flow of the cooling medium across at least the back face of the target support plate;
(ii) loading the low melting point target material into said plurality of slots in the target support plate;
(iii) placing the target support plate in a target holder apparatus;
(iv) irradiating the low melting point target material in the target support plate with a proton beam having an energy to induce a nuclear reaction in the low melting point target material to produce the radioisotope or the radionuclide;
(v) flowing the cooling medium across at least the back face of the target support plate during irradiation of the low melting point target material formed in the target support plate of the target;
(vi) collecting said irradiated low melting point target material from the target support plate by melting out said irradiated low melting point target material from the target support plate to separate the irradiated low melting point target material from the target support plate; and
(vii) separating from the collected separated irradiated low melting point target material the radioisotope or the radionuclide created from precursor material formed by the irradiation of the low melting point material.

27. The process for the production of a target for low melting point materials of claim 26, wherein the step of placing the target support plate in a target holder apparatus further comprises electroplating at least the plurality of slots in the target support plate with a layer of a barrier material selected from the group consisting of Gold (Au), Platinum (Pt), Iridium (Ir), Osmium (Os), Rhodium (Rh), Nickel (Ni), or a combination of thereof.
